(19) United States
(12) Patent Application Publication
(10) Pub. No.: US 2011/0276912 A1
(43) Pub. Date: Nov. 10, 2011

(54) AUTOMATING INTERNAL CONTROLS ASSESSMENTS FOR OUTSOURCED OPERATIONS

(75) Inventor: Nigel King, San Mateo, CA (US)

(73) Assignee: Oracle International Corporation, Redwood Shores, CA (US)

(21) Appl. No.: 12/774,466

(22) Filed: May 5, 2010

(51) Int. Cl. G06F 3/048

(52) U.S. Cl. 715/771

(57) ABSTRACT

A system and method for facilitating assessing business controls. To facilitate ensuring that a client's control objectives are met by a particular provider, the client may wish to ensure that the control objectives and applicable controls are specified in an SLA defining the relationship between the client and the service provider. In certain large enterprise applications, where a given client may contract with many providers, and the client itself may act as a provider to other clients, effective mechanisms for ensuring the existence of adequate functioning controls may become very complex and susceptible to failed oversight. In an example embodiment, the method includes making one or more descriptions of one or more business controls accessible to a user via a user interface; enabling a user to ascertain a business function characterizing a business relationship between a client and service provider, wherein the business function is associated with the one or more business controls; and providing a user option to adjust the one or more business controls.

### BACKGROUND

This application relates in general to assessment and/or manipulation of business controls and associated business relationships and more specifically to systems and methods that facilitate access to information characterizing client-provider relationships.

For the purposes of the present discussion, a client may be any business entity that requests or orders that one or more tasks be performed by a service provider. A service provider may be any business entity that implements or provides one or more business tasks on behalf of a client. An outsourced task may be any task performed for a client at the request of the client.

Systems and methods for monitoring, tracking, and/or manipulating client-provider relationships and associated controls are employed in various demanding applications, including generation of Statement on Auditing Standards (SAS)-70 audit reports and certifications, processes for selecting service providers to perform certain business functions, processes for selecting clients for solicitations, and so on. Such applications often demand efficient mechanisms for enabling rapid assessment of risks inherent in a given business relationship and assessment of controls for mitigating the risks.

Efficient mechanisms for ascertaining business risks and associated mitigating controls are particularly important in large enterprise applications characterized by multiple client-provider relationships, each with its own risks and associated mitigating controls. For example, a business (client) may hire an outside service organization (provider) to perform certain tasks, such as payroll processing, financial accounting, tax preparation, website hosting, insurance-claim processing, data processing, financial transaction processing, data hosting, and so on. Example service providers include certain payroll processing companies, Certified Public Accounts (CPAs), application service providers, bank trust departments, claims processing centers, data centers, third party network administrators, data processing service bureaus, and so on.

A given client, such as a payroll client, may rely upon a service provider to provide payroll taxes, information about retirement benefits, and so on. Similarly, a web hosting provider may provide website usage statistics, shopping cart services, sales reports, and so on, to a client. A task performed by a given provider may include one or more business functions or processes. Generally, a business process is a task that employs multiple functions to implement a particular series of sub-tasks or sub-processes. Each process is often subject to certain controls demanded by the client. For example, a payroll client may demand that employee social security numbers be kept secure. Such a demand or intent may be called a control objective. Examples of controls for implementing the control objective include systems for encrypting private data, security personal to guard the computers maintaining the data, electronic security surveillance equipment, and so on. Such features represent internal controls of the service provider. The desires of a client to have such controls implemented represent control objectives.

Various control objectives and associated controls may be implicit in a Service Level Agreement (SLA) between a client and a service provider. When a provider contracts with a new client, the client may demand that certain controls be specified in the SLA. Controls implemented by a given provider may be detailed in a report and/or certificate provided by an outside auditing firm or Certified Public Accountants (CPA) in accordance with the SAS-70 standard. A provider may present an SAS-70 audit certificate to a potential client that inquires about a provider's relevant internal controls.

To audit a provider, an auditor may scour a given SLA for clues as to control objectives and internal controls designed to meet the objectives. For certain types of audits, such as SAS-70, Type II audits, an auditor may further test the controls and provide an opinion as to their effectiveness for addressing a client's control objectives. Unfortunately, generation of such customized reports, which often require time consuming review of SLAs, can be undesirably costly.

A service provider or client may require periodic internal control audits as business activities change to ensure compliance with policies and agreements affecting data security, physical security, and so on. Certain types of SAS-70 audit reports may indicate whether control objectives and control activities are satisfactory; whether intended controls are being effectively implemented by a service provider; whether the implemented controls are suitable to meet control objectives; whether the implemented controls are operating effectively (as illustrated in certain Type II reports), and so on.

A client may have particular control objectives for particular providers. Audits of clients and/or service providers may reveal providers that do not have sufficient controls in place to meet the control objectives of certain clients. A given client may have several outsourced business processes or tasks, and the controls implemented by each service provider may require analysis. This analysis, i.e., auditing process, becomes increasingly complex, time consuming, and expensive as the number of outsourced business processes increases.

To facilitate ensuring that a client's control objectives are met by a particular provider, the client may wish to ensure that the control objectives and applicable controls are specified in an SLA defining the relationship between the client and the service provider. In certain large enterprise applications, where a given client may contract with many providers, and the client itself may act as a provider to other clients, effective mechanisms for ensuring the existence of adequate functioning controls may become very complex and susceptible to failed oversight.

### SUMMARY

An example method for facilitating assessing business controls includes: making one or more descriptions of one or more business controls accessible to a user via a user interface; enabling a user to ascertain a business function characterizing a business relationship between a client and service provider, wherein the business function is associated with the one or more business controls; and providing a user option to adjust the one or more business controls.

In an illustrative embodiment, the method further includes enabling a client user to generate a proposed Service Level Agreement (SLA) and to forward the proposed SLA to a service provider. An additional user option may be provided to enable a client user to electronically sign the SLA. An additional option may be provided to enable a service provider to electronically sign the SLA. An additional user option may enable the addition of one or more business controls to the SLA governing the relationship between the client and the service provider. Another user option may enable viewing of an audit report associated with the service provider.

Certain embodiments disclosed herein facilitate increasing the visibility of business controls for mitigating risks inherent in client/provider relationships. These controls often characterize the relationship between the client and the service provider and may be implicit in an accompanying SLA between the client and service provider. By increasing the visibility of business controls in an enterprise computing environment via one or more embodiments discussed herein, a business may obtain an improved ability to cost effectively manage risks, to conduct audits of controls for mitigating business risks, to select appropriate service providers to perform certain business functions, and to adjust applicable business controls as needed to meet changing business operating environments and practices.

A further understanding of the nature and the advantages of particular embodiments disclosed herein may be realized by reference of the remaining portions of the specification and the attached drawings.

### BRIEF DESCRIPTION OF THE DRAWINGS

FIG. 1 is a diagram illustrating a first example embodiment of a system for facilitating assessing controls and constructing Service Level Agreements (SLAs) based on the controls.

FIG. 2 is a diagram illustrating a first example dialog box adapted for use with the user interface software of the system of FIG. 1 and further adapted to facilitate establishing relationships between a business unit and outsourced and in-house business functions.

FIG. 3 is a diagram illustrating the first example dialog box of FIG. 2 with an outsourced-functions tab selected.

FIG. 4 is a diagram illustrating a second example dialog box that is accessible by selecting a find-service-provider button from the first example dialog box of FIG. 2.

FIG. 5 is a diagram illustrating a third example dialog box for appointing a service provider after selection of a send-outsourcing-solicitation button in the dialog box of FIG. 4 is selected.

FIG. 6 is a diagram illustrating a fourth example dialog box for reviewing an SLA, where the fourth example dialog box is accessible by selecting a draft-service-level-agreement button from the dialog box of FIG. 5.

FIG. 7 is a diagram of a fifth example dialog box for editing controls in an SLA, where the fifth example dialog box is accessible by selecting an edit-service-level-agreement button in the dialog box of FIG. 6.

FIG. 8 is a diagram of a sixth example dialog box for adding controls to an SLA, where the sixth example dialog box is accessible by selecting an add-new-internal-control button in the dialog box of FIG. 7.

FIG. 9 is a diagram illustrating an example data model that is adapted for use with the system of FIG. 1.

FIG. 10 is a diagram illustrating example process flows between functional software blocks that are adapted for use with the system of FIG. 1 and the dialog boxes of FIGS. 2-9.

FIG. 11 is a diagram illustrating additional example components of a client-business-unit-internal-audit block shown in FIG. 10.

FIG. 12 is a diagram illustrating additional example components of an external-audit block shown in FIG. 10.

FIG. 13 is a flow diagram of an example method adapted for use with the system of FIG. 1.

### DETAILED DESCRIPTION OF EMBODIMENTS

Although the description has been described with respect to particular embodiments thereof, these particular embodiments are merely illustrative, and not restrictive.

While the present application is discussed with respect to increasing the visibility of business controls and associated Service Level Agreements (SLAs) characterizing a relationship between a client and a service provider, embodiments are not limited thereto. For example, improved access to and documentation of business controls may facilitate other processes not limited to the construction of SLAs, such as a process of automating audits of business controls, and so on.

For the purposes of the present discussion, a business control may be any mechanism adapted to mitigate, control, or otherwise reduce a risk associated with a business function or process. A business function or process may be any activity or task performed by a business. An example business function includes payroll processing. An example business control includes database security features for restricting access to sensitive employee information contained in a database used for payroll processing.

An internal control may be any business control implemented by a business within the business. An external control may be any business control that is implemented by a second business entity on behalf of the first business entity as viewed from the perspective of the first business entity. Note that an external control associated with the first business entity may be an internal control of the second business entity.

An SLA may be an agreement, contract, or portion thereof that defines a relationship or aspect thereof between an entity (the provider) providing or to provide a service and an entity (the client, also called the customer) receiving or to receive a service from the provider.

For clarity, certain well-known components, such as hard drives, processors, operating systems, power supplies, Internet Service Providers (ISPs) and so on, have been omitted from the figures. However, those skilled in the art with access to the present teachings will know which components to implement and how to implement them to meet the needs of a given application.

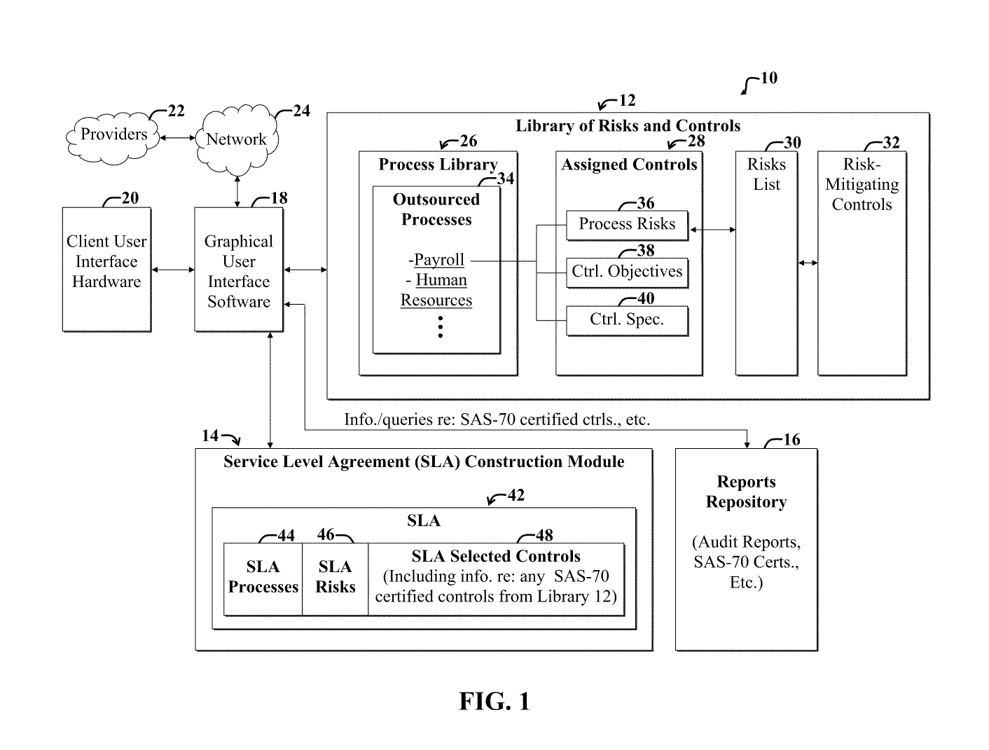

FIG. 1 is a diagram illustrating a first example embodiment of a system 10 for facilitating control assessment and for facilitating constructing Service Level Agreements (SLAs) based on the controls. The system 10 includes a library of risks and controls (risks/controls library) 12, an SLA construction module 14, and a repository of audit reports and certifications (reports repository) 16, which are accessible to graphical user interface software 18. The Graphical User Interface (GUI) software 18 is user accessible to a client employing the system 10 via client user interface hardware 20. One or more providers 22 may access the GUI software 18 via a network 24 that is in communication with the GUI software 18.

While the GUI software 18 is discussed with respect to providing user-interface functionality, such as the production of dialog boxes, and so on, the functionality of the GUI software 18 is not limited thereto, as discussed more fully below. For example, the GUI software 18 is further adapted to interface the library 12, SLA construction module 14, and reports repository 16 to facilitate transfer of information between the modules 12-16 in response to certain user input to the GUI software 18.

For the purposes of the present discussion, a dialog box may be any computer-generated graphical representation that includes one or more displayed mechanisms that are responsive to user input.

For illustrative purposes, the risks/controls library 12 is shown including a process library 26, which includes specifications of or descriptions of outsourced processes 34. By way of example, the outsourced processes 34 include a payroll process and a human-resources process.

The outsourced processes 34 may represent processes that have been outsourced by a client to a service provider, where the outsourced processes 34 are associated with one or more controls that are specified via the control specifications 40 in addition to control objectives 38 and the process risks 36 included in the assigned-controls module 28.

A user interface display screen, such as may be characterized by a dialog box, may be generated by the GUI software 18 and displayed via the user-interface hardware 20 to enable a user to associate a particular SLA with one or more selected controls pertaining to a selected process, as discussed more fully below.

For the purposes of the present discussion, an outsourced business function may be any business function that is to be performed (or is performed) at the request of a first business entity by a second business entity. A business process may be any task or set of tasks or business functions to be performed by a business entity. A business entity may be any business structure, organization, or department that is adapted to perform a predetermined set of functions or processes. The first business entity is typically called the client or customer, and the second business entity is called the service provider, or simply the provider. Note that the first business entity and the second business entity may be different business units or departments within an overall enterprise, without departing from the scope of the present teachings. Hence, the second business entity need not necessarily be a business entity that is entirely separate from the first business entity. Different business entities may be any business structures or organizations (e.g., departments) that exhibit different core functions.

The risks/controls library 12 further includes a module specifying assigned controls 28. The assigned-controls module 28 specifies, for each of the outsourced processes 34, certain assigned process risks 36, control objectives 38 associated with the risks, and control specifications 40 indicating or describing particular controls used to meet the control objectives 38 associated with the process risks 36. Note that the process risks 36 include risks from the risks list 30. In the present example embodiment, the assigned controls 28 may be configured by a client or provider via the GUI software 18.

The risks/controls library 12 further includes a list of risks 30 and an associated list of controls 32 for mitigating risks. A user may employ the GUI software 18 to view risks 30 and controls 32 for assignment to a particular outsourced process 34 and/or for inclusion in an SLA to be constructed via the SLA construction module 14 in response to certain user input provided by the GUI software 18.

The SLA construction module 14 includes an example SLA 42, which specifies SLA processes 44, risks 46 that have been associated with the SLA processes, and business controls 48 to be included in the SLA. The business controls 48 are adapted to mitigate the risks 46 associated with the SLA processes 44 that are the subject of the SLA 42.

In a first example operative scenario, a client user employs the user interface hardware 20 and GUI software 18 to view SLA controls 48, risks 46, and processes 44 existing in an SLA 42 between the client and one or more of the providers 22. The client may then employ the GUI software 18 to facilitate automatically generating an audit report with reference to the SLA 14, the risks/controls library 12, and any stored SAS-70 certifications applicable to a given service provider. The audit report may then stored in the reports repository 16 for easy access.

The reports-repository module 16 may act as an audit module and may include one or more routines for storing audit information and/or generating an audit of internal business controls. Audit results in the reports repository 16 may be user accessible via the GUI software 18. Note that the SLA controls 48 may include controls that have been certified by an SAS-70 certificate and information indicating which controls have been certified by one or more SAS-70 certificates. This information is accessible by the SLA construction module 14 with reference to the reports repository 16 via the GUI software 18.

In a second example operative scenario, a client user employs the GUI software 18 to view SAS-70 certifications for prospective providers that are associated with a particular process. The GUI software 18 includes instructions, i.e., code, for enabling a client user to send a solicitation to one or more prospective service providers that employ desired business controls for a process to be implemented by the one or more providers 22.

In a third example operative scenario, a client employs the GUI software 18 to generate a proposed SLA for a candidate service provider that is to perform a particular process. The client user may select, for inclusion in the SLA, business controls from the risk-mitigating controls 32 with reference to the risks 30 that are associated with a given process. Alternatively, or in addition, the client user may view and/or select previously assigned controls 28 if a given outsourced process 34 has already been registered in the risks/controls library 12. The SLA construction module 14 then employs the selected controls 48 and risks 46 for the processes 44 to be outsourced to construct a proposed SLA 42. The proposed SLA 42 may then be forwarded to one or more selected providers 22 for electronic signing. Once a provider signs a given SLA, the provider may forward the SLA back to the user client for electronic countersigning.

While the system 10 is discussed herein from the prospective of a client, note that a provider may also employ the system 10 to facilitate assessing risks and controls characterizing a given client/provider relationship.

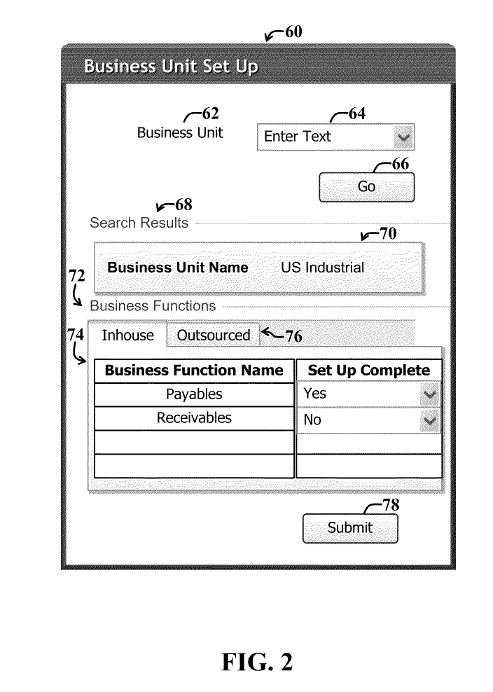

FIG. 2 is a diagram illustrating a first example dialog box 60 that is adapted for use with the GUI software 18 of the system of FIG. 1 and that is further adapted to facilitate establishing one or more relationships between a business unit and outsourced and/or in-house business functions. The dialog box 60 may be generated by the GUI software 18 of FIG. 1 and displayed via a display included in the user interface hardware 20 of FIG. 1.

The dialog box 60 includes a field identifying a business unit 62 for which business functions are to be set up and a search field 64 for entering a name of a business unit to be queried. A first go button 66 may be selected to initiate a search for a desired business unit. In the present example, a business unit called US Industrial is shown in a results field 70 in a search-results section 68. A business-functions section 72 includes tabs 74, 76, including an in-house-functions tab 74 and an outsourced-functions tap 76. Each tab, such as the in-house tab 74, illustrates various business functions, such as payables and receivables, and a corresponding indication illustrating whether the business functions have been set up with appropriate controls and/or SLAs, as discussed more fully below.

A user may select a submit button 78 to store contents of the dialog box 60 via the GUI software 18 of FIG. 1.

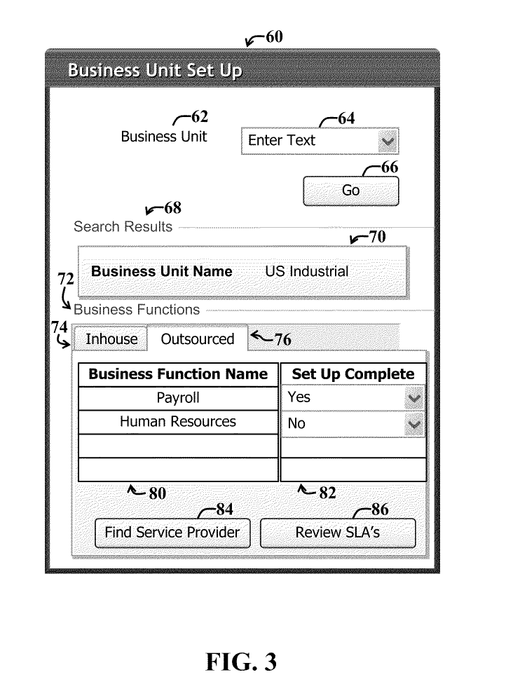

FIG. 3 is a diagram illustrating the first example dialog box 60 of FIG. 2 with the outsourced-functions tab 76 selected. In this example dialog box 60, additional buttons 84, 86 are provided in association with selection of the outsourced-functions tab 76.

The additional buttons 84, 86 include a find-service-provider 84 button and a Review-SLAs button 86. The outsourced-functions tab 76 includes a list of business functions 80 and a corresponding list of drop-down indicators 82 indicating whether setup for a given business function has been completed. The drop-down indicators 82 may act as toggle indicators such that a user may toggle the indications between “yes” and “no” to indicate whether the user has completed setting up the functions 80 as desired.

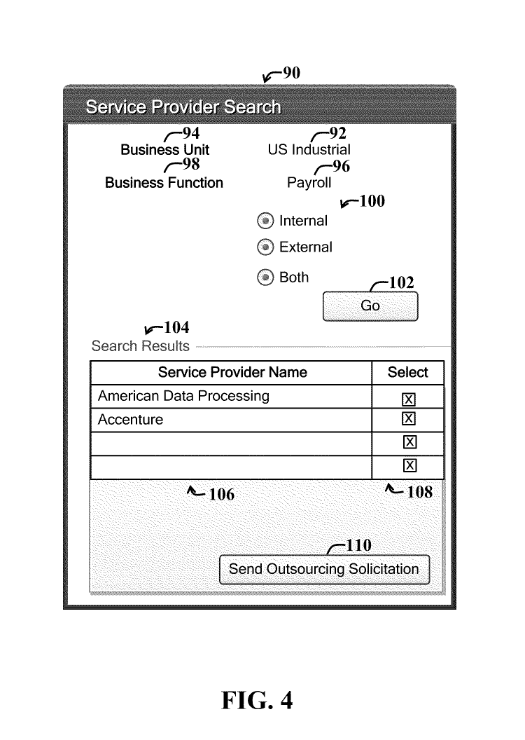

Upon selection of the find-service-provider button 84, an additional dialog box appears, as discussed more fully with reference to FIG. 4.

FIG. 4 is a diagram illustrating a second example dialog box 90 that is accessible by selecting the find-service-provider button 84 from the first example dialog box of FIG. 2.

The second example dialog box 90 represents a service-provider-search dialog box 90, which indicates that US Industrial 92 is the selected business unit 94, i.e., client, for which a provider is to be found. The relevant business function 98 to be outsourced to a provider is indicated as payroll 96. The payroll process 96 is to be subject to both internal and external controls, as indicted by radio-button identifiers 100. Upon selection of the business unit 94, the business function 98, and the control characteristics 100, a user may select a second go button 102 to implement a search for applicable service providers.

Example search results 106, 108 appear in a search-results section 104. The search results section 104 includes a list of service provider names 106 adjacent to check boxes 108. The check boxes 108 are used to select one or more service providers from the returned service providers 106.

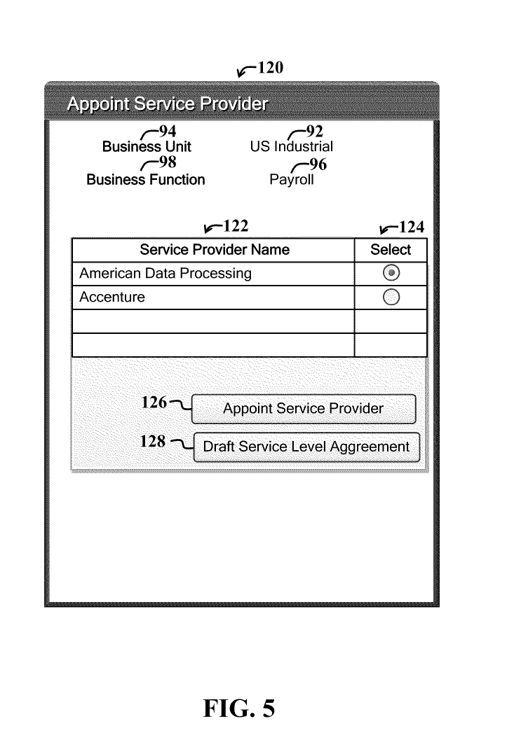

A user may select a send-outsourcing-solicitation button 110 to facilitate sending solicitations to the selected providers 106 to perform the payroll function 96 on behalf of the business unit client 92. Upon selection of the send-outsourcing-solicitation button 110, an additional dialog box may appear, as discussed more fully with reference to FIG. 5.

FIG. 5 is a diagram illustrating a third example dialog box 120, called an appoint-service-provider dialog box 120, for appointing a service provider after selection of the send-outsourcing-solicitation button 110 in the dialog box of FIG. 4 is selected.

The appoint-service-provider dialog box 120 includes identifications of the applicable client business unit 92, 94 and the applicable business function 96, 98. The dialog box 120 further includes a list of service provider names 122 that have responded to a solicitation to perform the payroll function 96. In the present example, a user has selected to use American Data Processing to implement a payroll function on behalf of the US Industrial business unit 92 client.

The appoint-service-provider dialog box 120 further includes an appoint-service-provider button 126 and a draft-service-level-agreement button 128. After selection of one of the service providers 122 via one of the corresponding radio buttons 124, the user may select the appoint-service-provider button 126. In the present example, selection of the appoint-service-provider button 126 may trigger storing of American Data Processing as the appointed service provider for the payroll business function 96. This information may be stored via the GUI software 18 of FIG. 1.

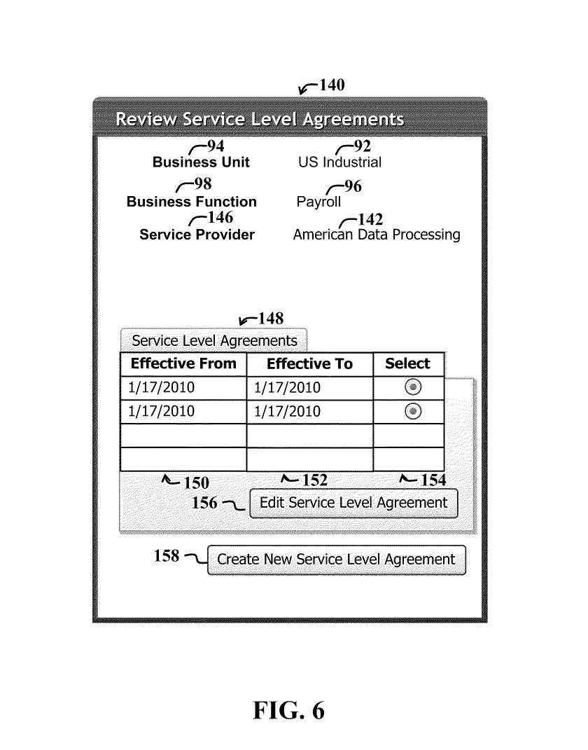

Selection of the draft-service-level-agreement button 128 may open a fourth dialog box to facilitate selecting controls for a SLA for construction of an SLA via the SLA construction module 14 of FIG. 1, as discussed with reference to FIG. 6.

FIG. 6 is a diagram illustrating a fourth example dialog box 140, called a review-service-level-agreements dialog box 140, for reviewing an SLA. The review-service-level-agreements dialog box 140 is accessible by selecting the draft-service-level-agreement button 128 from the dialog box of FIG. 5.

In the present example, the review-service-level-agreements dialog box 140 indicates that the SLA to be reviewed pertains to a business relationship between the US Industrial business unit client 92 and American Data Processing 142, which acts as the service provider for the payroll function 96 on behalf of the US Industrial business unit 92. The review-service-level-agreements dialog box 140 further includes a listing of SLAs 148 identified by effective dates of operation. The effective dates of operation are identified by a list of from dates 150 and effective-to dates 152. The SLA(s) 148 may be selected via corresponding radio buttons 154.

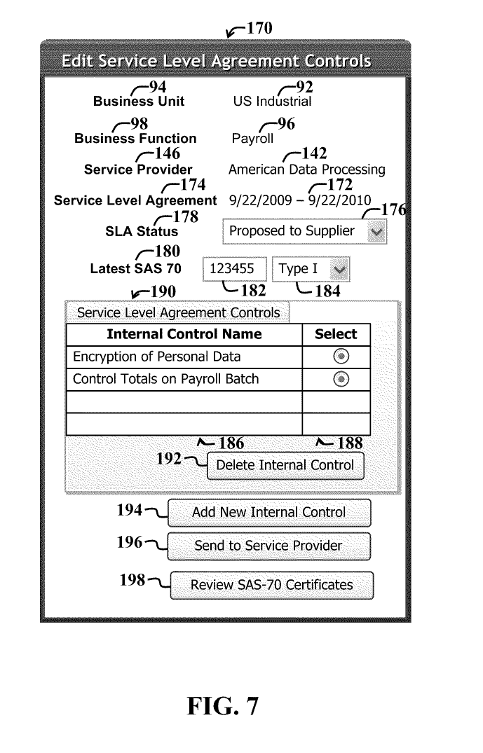

Upon user selection of one or more of the SLAs 148, a user may edit the SLA(s) or create a new SLA upon selection of an edit-service-level-agreement button 156 or upon selection of a create-new-service-level-agreement button 158, respectively. Upon selection of the edit-service-level-agreement button 156, a fifth example dialog box may appear, as discussed more fully with reference to FIG. 7.

FIG. 7 is a diagram of a fifth example dialog box 170, called an edit-service-level-agreement-controls dialog box 170, for editing controls in an SLA. The edit-service-level-agreement-controls dialog box 170 is accessible by selecting the edit-service-level-agreement button 156 in the dialog box 140 of FIG. 6.

The edit-service-level-agreement-controls dialog box 170 identifies the participating client 92, service provider 142, and outsourced business function 96 to be performed by the service provider 142 on behalf of the client 92. The edit-service-level-agreement-controls dialog box 170 further identifies a selected SLA 174 for editing, which is identified by its effective dates 172. A user may indicate a status 178 of the SLA by selecting from a status drop-down menu 176. Example selectable statuses may include “proposed to supplier,” “signed by supplier,” “countersigned by business unit,” and so on. Note that the SLA status 178 may be automatically selected via the GUI software 18 of FIG. 1 when the GUI software 18 has preexisting knowledge of the status of a particular SLA.

The edit-service-level-agreement-controls dialog box 170 further indicates any relevant Statement on Auditing Standards (SAS)-70 certifications associated with a given provider. The indications include a certificate number 182 and a certificate type 184. Note that an additional review-SAS-70-certificates button 198 is added to the dialog box 170 to facilitate direct access to contents of the SAS-70 certificate. Details of the certificate may be stored in the results repository 16 of FIG. 1.

The edit-service-level-agreement-controls dialog box 170 further includes a SLA-controls section 190, which includes a list of SLA controls 186 that are included in the identified SLA 172, 174 and corresponding radio buttons 188. The radio buttons 188 indicate whether corresponding listed controls 186 have been selected for inclusion in the SLA 172, 174.

The edit-service-level-agreement-controls dialog box 170 further provides a user option to delete one or more selected controls 186 via a delete-internal-control button 192. Additional buttons include an add-new-internal-control button 194, a send-to-service-provider button 196, and the review-SAS-70-certificates button 198.

Selection of the send-to-service provider button 196 may cause sending the edited SLA 172, 174 to the service provider 142 as a proposed SLA to facilitate electronic signing of the SLA 172, 174 by the provider 142. A returned signed SLA may be electronically countersigned by the client 192, as discussed more fully below.

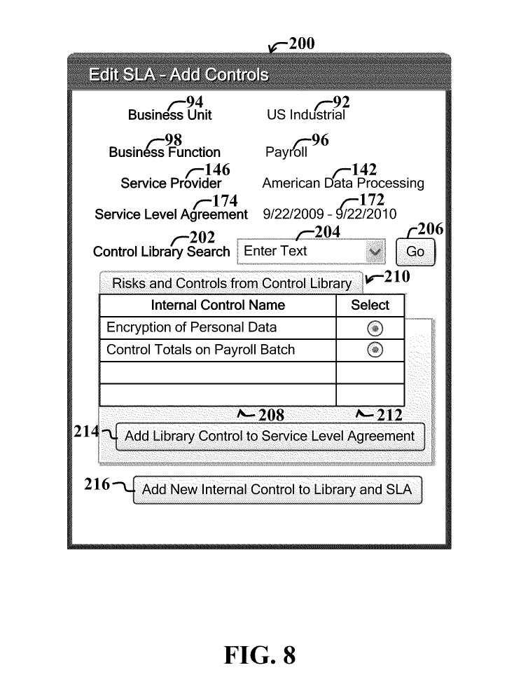

Upon selection of the add-new-internal-control button 194, an a sixth dialog box may appear to facilitate selection of one or more new internal controls for inclusion in the SLA 172, 174, as discussed more fully with reference to FIG. 8

FIG. 8 is a diagram of a sixth example dialog box 200, called an edit-SLA-Add-Controls dialog box 200, for adding controls to an SLA. The edit-SLA-Add-Controls dialog box 200 is accessible by selecting an add-new-internal-control button in the dialog box of FIG. 7.

The edit-SLA-Add-Controls dialog box 200 identifies the relevant client 92, service provider 142, function to be performed 96, and SLA 172, 174. A control library search 202 may be performed by entering a search term for a control in a search field 204 and then selecting a third go button 206. Returned controls are shown in a risk/controls section 210. The risk/controls section 210 lists controls 208 matching the search text 204. The listed controls 208 are retrieved from the risks/controls library 12 of FIG. 1.

The listed controls 208 are associated with selectable radio buttons 212, which facilitate selection of business controls to add to the SLA 172, 174.

A user may select an add-library-control-to SLA 214 to add one or more of the selected controls 208 to the SLA 172, 174. Alternatively, a user may choose to add a new business control to the SLA via selection of an add-new-internal-control-to-library-and-SLA button 216. Selection of the add-new-internal-control-to-library-and-SLA button 216 may result in display of an additional dialog box. The additional dialog box may enable a user may define one or more controls for inclusion in the risks/control library 12 of FIG. 1 and for inclusion in the SLA identified by the effective dates 172. Those skilled in the art with access to the present teachings may readily construct software for implementing such a dialog box and the dialog boxes of FIGS. 2-8 without undue experimentation.

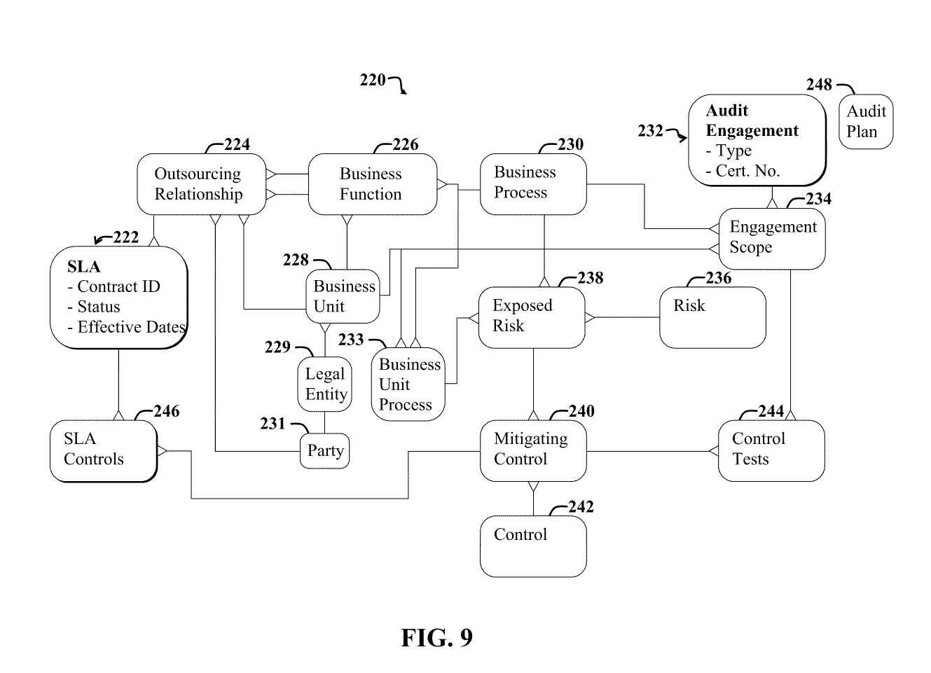

FIG. 9 is a diagram illustrating an example data model 220 that is adapted for use with the system 10 of FIG. 1. The data model 220 represents a simplified data model, which may be changed or adapted by those skilled in the art to meet the needs of a given implementation. The data model 220 illustrates example relationships between data employed by the system 10 of FIG. 1. The data and relationships depicted in the data model 220 may facilitate increasing the visibility of business controls, associated outsourced business relationships, and accompanying SLAs.

The data model 230 includes an SLA block 222, which includes data pertaining to one or more SLAs. Example data represented by the SLA block 222 includes identification numbers or indicia associated with an SLA and/or associated contract; status of an SLA, such as whether the SLA has been proposed, signed, countersigned, and so on; effective dates of enforcement of an SLA, and so on.

The SLA block 222 is coupled to an outsourcing-relationship block 224 via a connector indicating that plural SLAs may characterize a given outsourcing relationship between a given client and service provider. Note that in general, various connecting lines shown in FIG. 9 include a base (crows foot) from which each line extends to indicate a multiple-to-one relationship between a block coupled to the base of the connector and a block coupled to an opposite end of the connector. For example, the SLA block 222 is further coupled to an SLA-controls block 246 via a connector indicating that a given SLA represented by the SLA block 222 may include plural SLA controls represented by the SLA-controls block 246.

The outsourcing-relationship block 224 is further coupled to a business-function block 226 via a connector indicating that a given business function, represented by the business function block 226, may be associated with multiple outsourcing relationships. The multiple outsourcing relationships are represented by the outsourcing-relationship block 224. Two connectors are shown between the outsourcing-relationship block 224 and the business-function block 226 to indicate that an outsourcing relationship may encompass more than one business function.

The outsourcing-relationship block 224 is further coupled to a business-entity block 228 via a connector illustrating that a given business and/or corresponding legal entity, e.g., corporation, sole proprietorship, etc., may have plural outsourcing relationships. Furthermore, a business, as represented by the business lock 228, may implement or provide plural business functions, as represented via a connector coupling the business block 228 and the business-function block 226. The business block 228 is further coupled to an engagement-scope block 234 via a connector indicating that a given business entity may be associated with several different scopes of engagement with one or more clients.

A given legal entity 229 may be associated with plural business units corresponding to the business block 228. A given legal entity 229 may also be associated with a given party 231, such as a legal client that is a party to litigation or other party. A given party 231 may be associated with plural outsourcing relationships 224. A given business-unit process 233 may be associated with plural business functions 226 and a given business process 230. A given business process 230 may be associated with plural business unit processes 233. Plural business unit processes 233 may also be associated with a given business unit 228. Plural business unit processes 233 may be associated with plural scopes of audit engagement 234.

The business-function block 226 is further coupled to a business-process block 230 via a connector indicating that a given business process may be associated with plural business functions or sub-tasks. The business-process block 230 is further coupled to the engagement-scope block 234 via a connector indicating that a given business process may be associated with plural different scopes of engagement. The business process block 230 is further coupled to an exposed-risk block 238 via a connector indicating that a given business process may be associated with plural different exposed risks. The exposed risk block 238 is further connected to a risk block 236 via a connector indicating that a given risk category may be associated with plural exposed risks. The exposed risk block 238 is further coupled to a mitigating-control block 240 via a connector indicating that a given exposed risk 238 may be addressed by plural mitigating controls.

The mitigating-control block 240 is coupled to a control-test block 244 indicating that a given mitigating control may be subject to plural different control tests. The mitigating-control block 240 is further coupled to a general control block 242 via a connector indicating that a given control category may be associated with plural mitigating controls. The mitigating-control block 240 is further coupled to the SLA-controls block 246 indicating that a mitigating control 240 may be used in plural SLAs or may otherwise be associated with plural instances of SLA controls.

The control-tests block 244 is further coupled to the engagement-scope block 234 via a connector indicating that a particular engagement scope may be associated with plural control tests. The engagement-scope block 234 is further coupled to an audit-engagement block 232 via a connector indicating that a particular audit engagement may be associated with plural engagement scopes. Example data represented by the audit-engagement block 232 includes audit type, audit certification number, and so on.

Furthermore, the various blocks 222-246 may be associated with one or more audit plans 248, and one or more audit plans 248 may be applicable to one or more of the entities represented by the various blocks 222-246. For clarity, various connectors between the audit plan 248 and the various blocks 222-246 are omitted.

Generally, the data model 220 represents a new category of data model that includes an SLA block 222, SLA controls 246, and the audit-engagement block 232, which are largely absent from existing data models characterizing enterprise-management software, such as Enterprise Resource Planning (ERP) software.

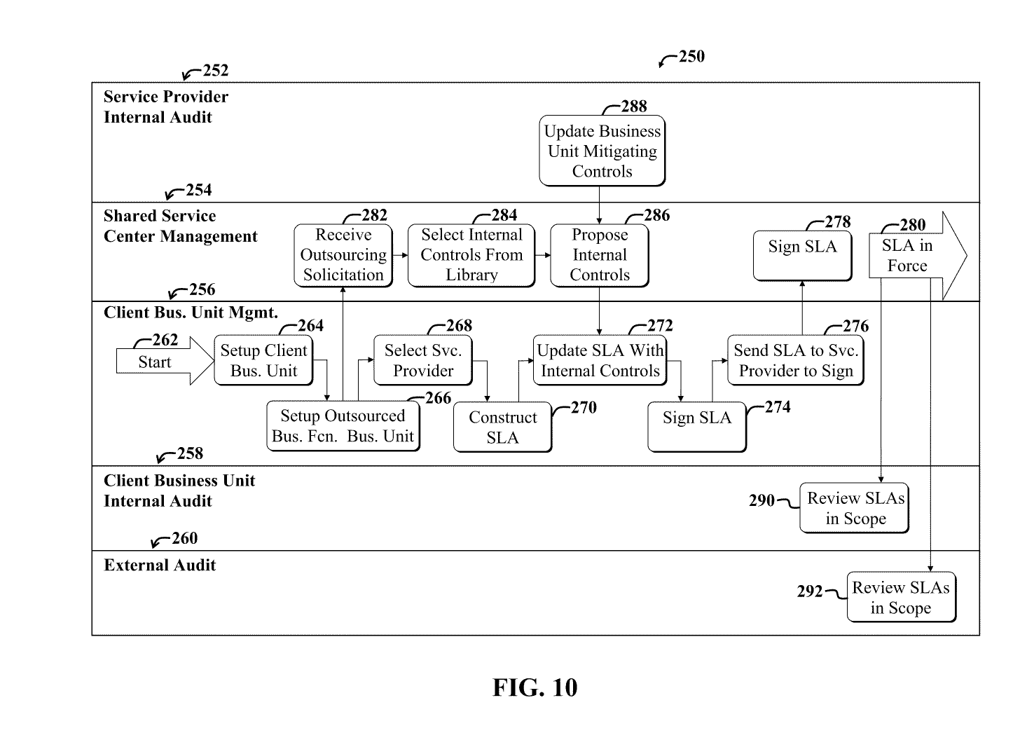

FIG. 10 is a diagram illustrating example process flows 250 between functional software blocks 252-260 that are adapted for use with the system 10 of FIG. 1. The various blocks 252-260 may correspond to functionality facilitated by the dialog boxes of FIGS. 2-8.

The functional blocks 252-260 include a service-provider-internal-audit block 252, which communicates with a shared-service-center-management block 254, which communicates with a client-business-unit-management block 256, which communicates with a client-business-unit-internal-audit block 258, which communicates with an external-audit block 260.

In the present example process flow 250, a start indicator 262 is shown in the client-business-unit-management block 256. At the start of the process 250, a client-business-unit-setup step 264 is performed. The client-business-unit-setup step 264 may include implementing various set-up functions, such as selection of a business unit, association of internal and external business functions or processes associated with the business unit, and so on, as shown in the dialog boxes 60 of FIGS. 2 and 3.

Subsequently, a setup-outsourced-business-function step 266 may be performed, wherein a particular business function to be outsourced is selected. Selection of a particular business function via step 266 may correspond to the business-functions section 72 of the dialog box 60 of FIG. 3.

Next, a user may chose to send an outsourcing solicitation to a service provider perform a selected outsourced function. The outsourced solicitation may be received by a service provider via the shared-service-center-management block 254 at a receive-outsourcing-solicitation block 282. Upon receipt of an outsourcing solicitation from a prospective client, a provider may select controls, such as controls from the control library 12 of FIG. 1, at a select-internal-controls step 284. The controls selected at step 284 are selected for inclusion in a set of proposed internal controls associated with a proposed-internal-controls step 286. The proposed internal controls 286 may include controls resulting from updating of business-unit mitigating controls in block 288, such as in response to an internal auditing process represented by the service-provider-internal-audit block 252.

The proposed internal controls produced via the propose-internal-controls step 286 may be fed to an update-SLA step 272 that is included in the client-business-unit-management block 256. The update-SLA step 272 may also be arrived at via a process flow implemented primarily within the client-business-unit-management block 256 after outsourced business functions have been set up at the setup-outsourced-business-function step 266; after one or more service providers have been selected for one or more business functions in step 268; and after an SLA has been constructed in response to user input from a client at step 270. An SLA resulting from the SLA-construction step 270 may be updated with internal controls 272 by the client and/or in response to proposed internal controls that are proposed by a provider at the propose-internal-controls step 286.

After the update-SLA step 272 is performed, a client may electronically sign the SLA at step 274 and then forward the signed SLA to a provider via an SLA-sending step 276. The SLA may then be signed by a provider at step 278. After signing of the SLA by the client and provider, the SLA is considered to be in force at final step 280. The in force SLA may be accessed by one or more processes implemented by the client-business-unit-internal-audit block 258 and the external-audit block 260. An example process step performed by the client-business-unit-internal-audit block 258 includes a review-SLA-scope step 290, which involves review of the scope of a signed and in-force SLA. An example process step performed by the external-audit block 260 includes a request-SLA step 292, which involves requesting a copy of an in-force SLA after completion of the final step 280.

Note that the process flow 250 of FIG. 10 is merely illustrative, and several variations are possible. For example, before the client signs the SLA at step 274, the provider may first sign the SLA at step 278 instead of vice versa, without departing from the scope of the present teachings. Furthermore, certain steps may be omitted in certain applications. For example, certain applications may not require that a provider propose internal controls at step 286. Furthermore, functionality and/or steps may be included to facilitate enabling a provider to solicit business from a client.

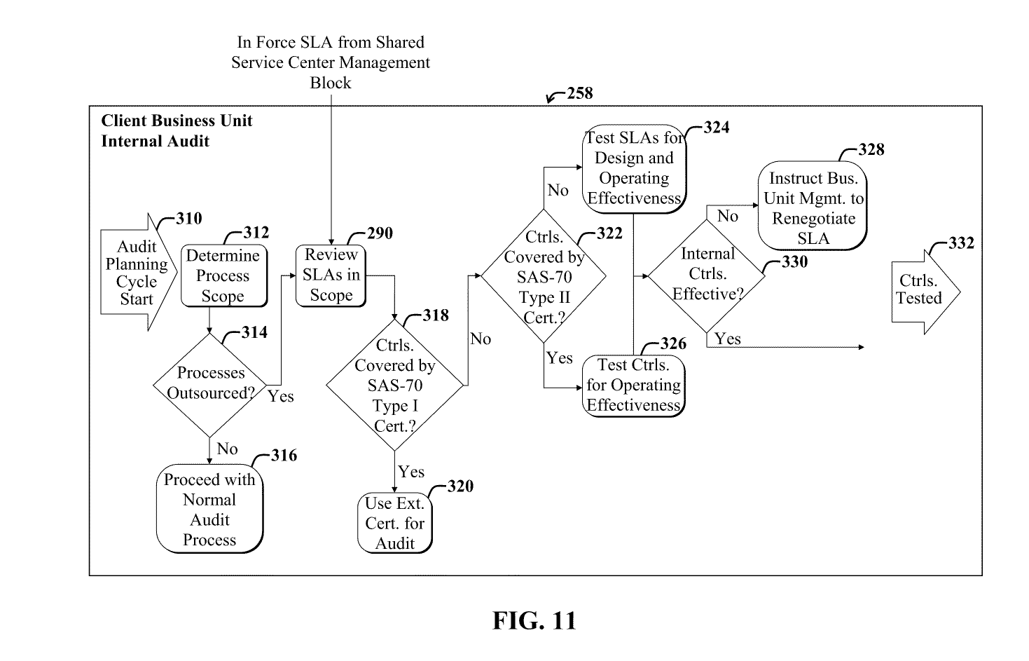

FIG. 11 is a diagram illustrating additional example components of the client-business-unit-internal-audit block 258 of FIG. 10. Key functional components of the example client-business-unit-internal-audit block 258 collectively represent a process flow that may be implemented in software.

The process flow involves starting an audit planning cycle 310 and then determining a scope of the applicable audit process, such as with reference to an audit plan. Subsequently, if the audit process does not represent an outsourced process, as determined at an outsourcing-determination step 314, then a predetermined existing internal auditing procedure is employed for the audit process in a normal-audit-processing step 316. Otherwise, in-force SLAs that are within the scope of the audit process are reviewed in an SLA-reviewing step 290. With reference to FIGS. 10 and 11, one or more applicable in-force SLAs 280 may be retrieved from the shared-service-center-management block 254. With reference to FIGS. 7 and 11, a user may access software functionality to facilitate review of SLAs at step 290 of FIG. 11 by selecting the review-SLA button 86 of FIG. 7.

If a review of the applicable SLAs indicates that one or more controls associated with an applicable SLA are covered by an SAS-70 Type I audit certificate, as determined in a first certification-type-checking step 318, then an existing applicable SAS-70 Type I audit certificate is used for the auditing process in an existing-certification step 320. Otherwise, a second certification-type-checking step 322 is performed. Step 322 determines whether the scope of the current audit process includes controls that are covered by an SAS-70 Type II certification. If applicable controls are governed by an SAS-70 Type II certificate, then controls are tested for operating effectiveness at a first control-testing step 326. Otherwise, the applicable controls are neither covered by an SAS-70 Type I or II certificate. In this case, the existing SLAs are tested for design and operating effectiveness at a second control-testing step 326.

After the control-testing steps 324, 326, a determination as to the effectiveness of the internal controls is made at a control-effectiveness-checking step 330. If the tested internal controls passed a predetermined effectiveness test, then the process implemented via the client-business-unit-internal audit block 258 is complete, as represented by a controls-tested arrow 332. Otherwise, a management-notification step 328 is performed, whereby applicable business-unit management personnel are notified accordingly and/or instructed to renegotiate the applicable SLA associated with the ineffective internal controls.

Hence, the client-business-unit-internal audit block 258 is particularly useful to facilitate an internal audit of a business entity via an independent auditor. An independent auditor may perform a software-facilitated controls-verification process in accordance with the client-business-unit-internal audit block 258.

SAS-70 audits may are often applicable, for example, when an independent auditor (“user auditor”) is planning the financial-statement audit of an entity (“user organization”) that obtains services from another organization (“service organization”). Examples of service organizations that may impact a user organization's system of internal controls include Application Service Providers (ASPs), bank trust departments, claims-processing centers, data centers, third party administrators, other data-processing service bureaus, and so on.

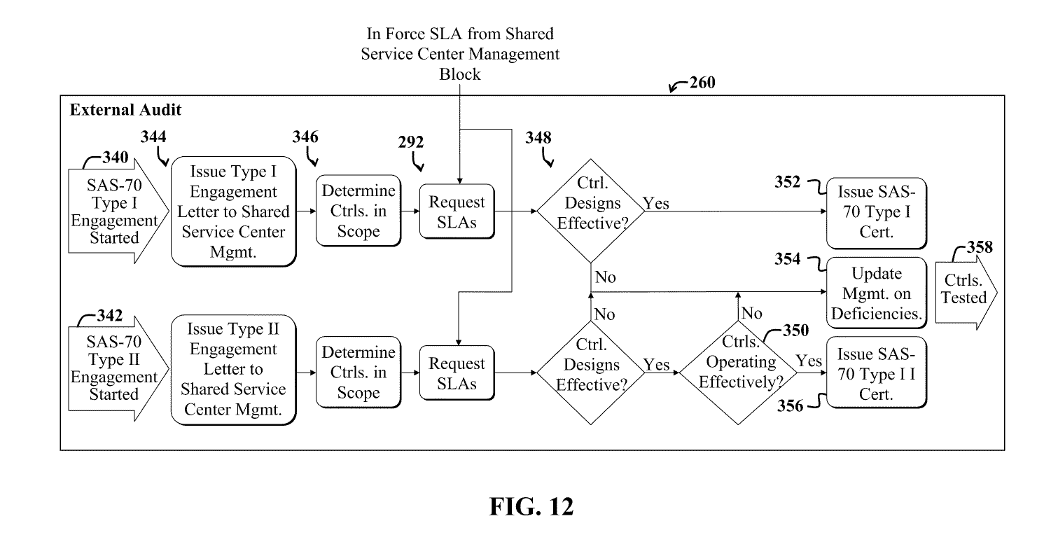

FIG. 12 is a diagram illustrating additional example components of the external-audit block 260 of FIG. 10. Key functional components of the example external-audit block 258 collectively represent a process flow that may be implemented in software.

The process flow involves starting an SAS-70 Type I auditing process at an initial Type-I-audit-engagement step 340 and/or starting an SAS-70 Type II auditing process at an initial Type-II-audit-engagement step 342. After a Type I or II auditing process is initiated, appropriate audit-engagement letters are issued to applicable shared-service-center management at letter-issuing steps 344.

Subsequently, controls to be audited, i.e., controls that are within the scope of the SAS-70 Type I and/or Type II audit are identified in control-identification steps 346. Any SLAs associated with the controls are retrieved at SLA-requesting steps 292. Applicable SLAs may be retrieved via the shared-service-center-management block 254 of FIG. 10.

Subsequent control-design checking steps 348 involve employing one or more predetermined criterion or criteria to determine if applicable controls are designed effectively. If the controls associated with an applicable SAS-70 Type I audit are designed effectively, then a corresponding SAS-70 Type I certificate is issued at a Type-I-certification step 352. If the designs of controls that are within the scope of a SAS-70 Type I and/or Type II audit are deficient, i.e., the control designs fail to meet applicable predetermined criteria, then management is informed of the deficiencies at a management-updating step 354.

If an SAS-70 Type II audit is being performed, an additional control-operation-testing step 350 is performed. If the subject controls are designed effectively, and the controls are operating effectively, then a corresponding SAS-70 Type II certificate is issued at a Type-II certification step 356.

After completion of one or more applicable steps 352-356, applicable controls have been tested, i.e., audited, and the process flow associated with the external-audit block 260 is complete.

Various functionality provided by the external-audit block 260 enables an auditor, such as an external auditor, to quickly and effectively perform SAS-70 audits and issue appropriate SAS-70 Type I or II certificates. Such functionality is particularly useful to service providers wishing to employ an independent auditor to certify that controls are appropriately designed; are working effectively; and are not deficient in other ways, e.g., characterized by material weakness.

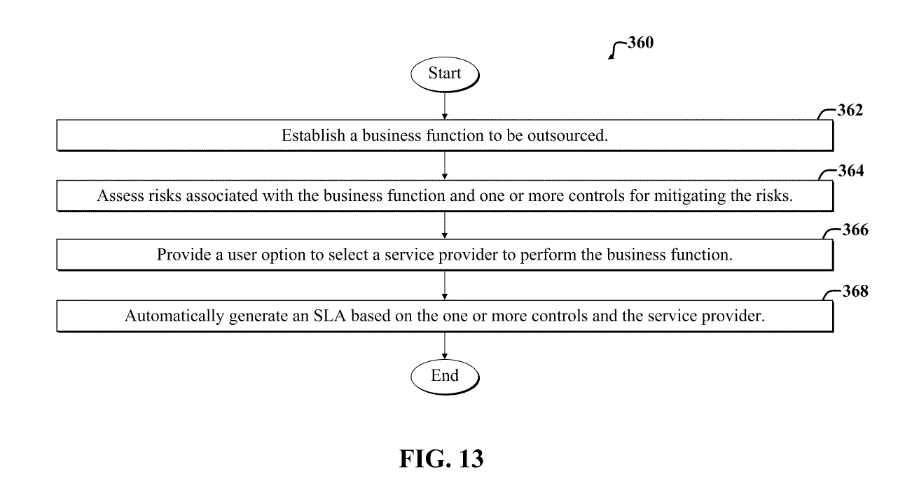

FIG. 13 is a flow diagram of an example method 360 adapted for use with the system 10 of FIG. 1. The method 360 includes a first step 362, which includes establishing a business function, such as payroll processing, tax preparation, employee benefits enrollment, etc., to be outsourced.

A second step 364 includes assessing one or more risks associated with the business function and one or more controls that are adapted to mitigate the risks. Example risks include exposure of sensitive data, such as employee social security numbers. Example controls include security features in a database that maintains employee social security numbers. Note that selection of a particular control that has been previously assigned to a given risk is equivalent to the combination of assessing the risk and selecting the appropriate mitigating control.

A third step 366 includes providing a user option to select a service provider to perform a particular business function. Selection of a service provider may take into account internal controls implemented by the service provider and whether a given service provider can implement desired controls, i.e., control objectives of a particular client.

A fourth step 368 includes automatically generating an SLA based on the one or more controls and the selected service provider.

Note that the example method 360 is merely illustrative. The method 360 may be modified, such as by interchanging the order of certain steps 362-368, adding additional steps, omitting certain steps, and so on, without departing from the scope of the present teachings.

An example alternative method includes: making one or more descriptions of one or more business controls accessible to a user via a user interface; enabling a user to ascertain a business function characterizing a business relationship between a client and service provider, wherein the business function is associated with the one or more business controls; and providing a user option to adjust the one or more business controls.

The various methods, process flows, systems, user interface functionality, and soon, described herein may be adapted to run on various processing systems, such as one or more computers. A data storage device, such as hard drive, may accommodate storage of data in the databases and/or storage of computer readable instructions for implementing certain functionality described herein.

Any suitable programming language can be used to implement the routines of particular embodiments including C, C++, Java, assembly language, etc. Different programming techniques can be employed such as procedural or object oriented. The routines can execute on a single processing device or multiple processors. Although the steps, operations, or computations may be presented in a specific order, this order may be changed in different particular embodiments. In some particular embodiments, multiple steps shown as sequential in this specification can be performed at the same time.

Particular embodiments may be implemented in a computer-readable storage medium for use by or in connection with the instruction execution system, apparatus, system, or device. Particular embodiments can be implemented in the form of control logic in software or hardware or a combination of both. The control logic, when executed by one or more processors, may be operable to perform that which is described in particular embodiments.

Particular embodiments may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of particular embodiments can be achieved by any means as is known in the art. Distributed, networked systems, components, and/or circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

Thus, while particular embodiments have been described herein, latitudes of modification, various changes, and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

We claim:

1. A method for assessing business controls, the method comprising:
making one or more descriptions of one or more business controls accessible to a user via a user interface;
enabling a user to ascertain a business function characterizing a business relationship between a client and service provider, wherein the business function is associated with the one or more business controls; and
providing a user option to adjust the one or more business controls.

2. The method of claim 1, wherein providing includes enabling a client user to generate a proposed Service Level Agreement (SLA) and to forward the proposed SLA to a service provider.

3. The method of claim 2, wherein providing further includes providing an option to a client to electronically sign the SLA and an option to a service provider to electronically sign the SLA.

4. The method of claim 2, wherein providing further includes providing an option to add one or more business controls to an SLA associated with the relationship between the client and the service provider.

5. The method of claim 4, further including providing a user option to view an audit report associated with the service provider.

6. The method of claim 5 further including providing a first user option to create an SAS-70 certificate and a second user option to store the SAS-70 certificate, wherein the audit report includes the SAS-70 certificate.

7. A system for assessing business controls associated with an existing or prospective outsourced business relationship, the system comprising:
a computer-readable storage mechanism containing information pertaining to one or more risks and one or more corresponding mitigating controls;
a Service Level Agreement (SLA) module adapted to facilitate construction of an SLA between a business and a service provider based on the information in the computer-readable storage mechanism; and
an interface module adapted to coordinate information flow between the computer-readable storage mechanism and the SLA module in response to user input thereto.

8. The system of claim 7, wherein the interface module further includes software adapted to facilitate producing one or more dialog boxes that are adapted to receive the user input.

9. The system of claim 8, wherein the one or more dialog boxes include a first dialog box that is adapted to enable a user to select a business function to be outsourced to a service provider on behalf of a client.

10. The system of claim 8, wherein the one or more dialog boxes include a second dialog box that is adapted to enable a user to search for a service provider to perform a particular business function.

11. The system of claim 8, wherein the one or more dialog boxes include a third dialog box that is adapted to enable a user to select a service provider to perform a particular business function.

12. The system of claim 8, wherein the one or more dialog boxes include a fourth dialog box that is adapted to enable a user to review an SLA associated with performance of a business function by a service provider.

13. The system of claim 8, wherein the one or more dialog boxes include a fifth dialog box that is adapted to enable a user to edit an SLA associated with the performance or a business function by a service provider on behalf of a client.

14. The system of claim 13, wherein the one or more dialog boxes include a sixth dialog box that is adapted to enable a user to add a specification of a business control to the SLA and to provide a proposed SLA in response thereto.

15. The system of claim 7, wherein the computer-readable storage mechanism includes a process library that specifies one or more outsourced processes that have been outsourced by a client to a service provider.

16. The system of claim 15, wherein the computer-readable storage mechanism includes a library module that includes information associating one or more outsourced processes with one or more controls.

17. The system of claim 7, wherein the SLA module includes a mechanism for associating an SLA with one or more selected controls pertaining to a selected process.

18. The system of claim 7, further including an audit module in communication with the interface module, wherein the audit module is adapted to store audit information pertaining to an audit of business controls.

19. The system of claim 18, wherein the audit information is adapted to be accessible to a user via the interface module.

20. The system of claim 7, wherein the computer-readable storage mechanism includes a control library that includes a specification of one or more controls included in the SLA, and wherein the one or more controls are associated with one or more SAS-70 certificates.

21. A method for assessing one or more business controls to facilitate configuring a business relationship between a client and a service provider, the method comprising:
establishing a business function to be outsourced;
assessing one or more risks associated with the business function and one or more controls that are adapted to mitigate the risks;
indicating a service provider to perform the business function and providing an indication of a selected service provider in response thereto; and
automatically generating a Service Level Agreement (SLA) based on the one or more controls and the selected service provider.
